(19) United States
(12) Patent Application Publication
(10) Pub. No.: US 2025/0123391 A1
(43) Pub. Date: Apr. 17, 2025

(54) EXPLOITING DIFFRACTION FOR SENSING WITH RF SIGNALS AND/OR FOR RF FIELD PROGRAMMING

(71) Applicant: THE REGENTS OF THE UNIVERSITY OF CALIFORNIA, Oakland, CA (US)

(72) Inventors: Yasamin Mostofi, Goleta, CA (US); Anurag Pallaprolu, Goleta, CA (US); Belal Korany, San Diego, CA (US); Winston Hurst, Goleta, CA (US)

(21) Appl. No.: 18/904,812

(22) Filed: Oct. 2, 2024

Related U.S. Application Data
(60) Provisional application No. 63/544,083, filed on Oct. 13, 2023.

(51) Int. Cl. G01S 13/89; H04B 7/06; H04B 17/318

(52) U.S. Cl. CPC G01S 13/89; H04B 7/0626; H04B 17/318

(57) ABSTRACT

A method of sensing attributes of an area, a scene or an entity of interest includes receiving at one or more receiving units a signal transmitted from one or more transmitting units, measuring one or more attributes of the received signal; and using, at least in part, wave diffraction principles for sensing. A method, system, and/or device for focusing signal waves, such as for RF field programming, via, at least in part, exploiting principles of diffraction.

### STATEMENT REGARDING FEDERALLY SPONSORED RESEARCH OR DEVELOPMENT

This invention was made with government support under grant 1816931 from the National Science Foundation and award N00014-20-1-2779 from the Office of Naval Research. The government has certain rights in the invention.

### BACKGROUND

The number of wirelessly-connected devices has been growing rapidly in recent years, making wireless signals, such as WiFi, ubiquitous. This has resulted in a considerable interest in using radio signals beyond communication, and for sensing and learning about the environment.

In general, imaging, sensing, and context inference about objects and humans is important for many applications, from smart home, smart health, to structural health monitoring, to search and rescue, surveillance, and excavation, just to name a few. While cameras can be used for imaging and sensing, they fail to do so through occlusions/walls and/or in low-light conditions, and they can invade privacy. As such, if details of objects could be obtained with cheap ubiquitous WiFi devices, it can open up new possibilities for many applications, and can be complementary to the existing sensors for imaging, sensing or context inference.

On the other hand, there has been considerable interest in recent years in programming the radiofrequency (RF) field, in order to generate different desired radio frequency field patterns over the space. This can be important for both communication and sensing applications. For instance, by generating a strong beam at a certain location or direction in space, one can create a good communication quality for a user at that location. Similarly, such a strong beam can also be used for better sensing at that direction/location with RF signals. Alternatively, the transmitter may want to minimize the field at certain locations/directions in space where there are no users.

### SUMMARY

According to one aspect, a method of sensing attributes of an area, a scene or an entity of interest includes receiving at one or more receiving units a signal transmitted from one or more transmitting units, measuring one or more attributes of the received signal; and using, at least in part, wave diffraction principles for sensing.

According to one aspect, a method includes generating an image of edge elements, wherein each generated edge element corresponds to a surface of an entity in the area of interest whose radius of curvature is small.

According to another aspect, a device for RF field programming, multi-beam focusing, or beam-forming includes a plurality of diffraction-inducing components.

According to a further aspect, a method for RF field programming, multi-beam focusing or beam-forming includes transmitting signals from one or more transmitters; utilizing at least in part a plurality of diffraction-inducing components; determining, adjusting, or reconfiguring the characteristics of at least some of the diffraction-inducing components, wherein said characteristics affect the diffraction properties of the components; and generating the desired RF field by using, at least in part, diffraction principles to model the relationship between the characteristics of the diffraction-inducing components and the resulting field.

### BRIEF DESCRIPTION OF THE DRAWINGS

FIG. 1 is a schematic of a system for sensing, imaging or context inference using at least in part wave diffraction principles, according to some embodiments.

FIG. 2 is a schematic of a device for sensing, imaging or context inference using at least in part wave diffraction principles, according to some embodiments,

FIG. 3 is an illustration of an object that may be located in an imaging space, according to some embodiments.

FIG. 4 is a flowchart of a method for sensing, imaging, and/or building an understanding of the area, using diffraction principles, according to some embodiments.

FIG. 5 is a flowchart of a method for sensing, imaging, and/or building an understanding of an area, using Geometrical Theory of Diffraction and/or the corresponding Keller cones, according to some embodiments.

FIG. 6 is a graphical illustration of an information propagation algorithm utilized in some embodiments to propagate the deduced information of the imaged edges throughout the imaging spaces.

FIG. 7 is a schematic illustrating a specularly-reflected wave off of a mirror point, according to some embodiments.

FIG. 8 is a schematic illustrating a sample edge interaction and the resulting Keller cone 50, according to some embodiments. Different conic sections that may be generated by the interaction of the incident wave 802 onto a point 824 of an edge 824 of an object 810 are also illustrated on the Keller cone 50 (hyperbola 80, parabola 82, ellipse 84, circle 86).

FIG. 9 is a schematic illustrating a Keller cone 51 generated by an incident wave 902 interacting with an edge point 924 on object 910. In this example, the intersection of the Keller cone 50 with a receiver array 902 produces a conic section that is a circle 86. A bold line 86 indicates the signals 10 detected by the receiver array 902.

FIG. 10 is a schematic illustrating a Keller cone 52 generated by an incident wave 1002 interacting with an edge point 1024 on object 1010. In this example, the intersection of the Keller cone 52 with a receiver array 1002 produces a conic section that is a hyperbola 80a. A bold line indicates the signals 11 detected by the receiver array 1002.

FIG. 11 is a schematic illustrating a Keller cone 53 generated by an incident wave 1102 interacting with an edge point 1124 on object 1110. In this example, the intersection of the Keller cone 53 with a receiver array 1102 produces a conic section that is an ellipse 84. A bold line indicates the signals 12 detected by the receiver array 1102.

FIG. 12 is a schematic illustrating a Keller cone 54 generated by an incident wave 1202 interacting with an edge point 1224 on object 1210. In this example, the intersection of the Keller cone 54 with a receiver array 1202 produces a conic section that is a hyperbola 80b. A bold line indicates the signals 13 detected by the receiver array 1202.

FIG. 13 is a schematic illustration 80 comparing images generated before application of an information propagation algorithm (FIGS. 13A and 13C) to images after application of an information propagation algorithm (FIGS. 13B and 13D), according to some embodiments.

FIG. 14 is a schematic illustration 82 of images generated by steps 405, 410, 420, and 430 of the method illustrated in FIG. 4.

FIG. 15 is a schematic illustration 84 of images generated by steps 405, 410, 420, 430, 440 of the method illustrated in FIG. 4, according to some embodiments.

FIG. 16 is a schematic illustration 90 of images generated by a traditional radiofrequency imaging method. FIG. 16A is an image of the letter H. FIG. 16B is an image of the letter M.

FIG. 16C is an image of the letter L. Solid lines in each image outline the contours of the letter that is the subject of the image.

FIG. 17 is a schematic of a system for radiofrequency field programming, according to some embodiments.

FIG. 18 is a schematic of a RF diffraction element with a plurality of edge elements used for RF field programming, according to some embodiments.

FIG. 19 is a flowchart of a method for determining the characteristics of the diffraction-inducing components (e.g., orientations of the edge elements) in order to generate a desired RF field, according to some embodiments.

FIG. 20 is a schematic illustrating a Keller cone generated by an incident ray interacting with an edge point on an edge element, according to some embodiments.

FIG. 21 is a method to change the characteristics of the diffraction-inducing components (e.g., orientations of edges) in order to focus the field on a given desired direction/point, according to some embodiments.

FIG. 22 is a flowchart of a method to orient a plurality of edge elements for multi-point/direction focusing and beam forming, according to some embodiments.

FIG. 23 is a flowchart of a method for assigning edge elements to mutually exclusive subsets, according to some embodiments.

FIG. 24 is a flowchart of a method for manufacturing a RF diffraction element, according to some embodiments.

### DETAILED DESCRIPTION

The present disclosure describes/provides a method, system, and/or device for sensing, imaging, context inference and/or building an understanding of an area, using RF signals and via, at least in part, exploiting principles of diffraction and a method, system, and/or device for focusing signal waves, such as for RF field programming, via, at least in part, exploiting principles of diffraction.

### Sensing and Imaging Via Exploiting Diffraction

Overall, WiFi signals have shown promises for sensing, in the applications where there is motion (e.g., body motion), since extracting information from movements is an easier task. However, imaging details of objects with every-day radiofrequency (RF) signals, such as WiFi power measurements, has remained a considerably challenging problem due to the lack of motion. The imaging method described herein images, or traces, the edges of an object, objects, scenery, entities, or humans, utilizing the interaction between one or more transmitted signal and surfaces with small enough curvatures in the imaging area of interest by exploiting principles of diffraction, for instance the Geometrical Theory of Diffraction (GTD) and the corresponding Keller cones. The method/system disclosed herein does not require specialized and/or expensive equipment to produce high quality images of objects in different imaging environments. Further, in some embodiments, a deep neural network is not required to image the object. A drawback of deep neural networks for imaging is that they are specific to the configurations/objects they were trained with and do not generalize well.

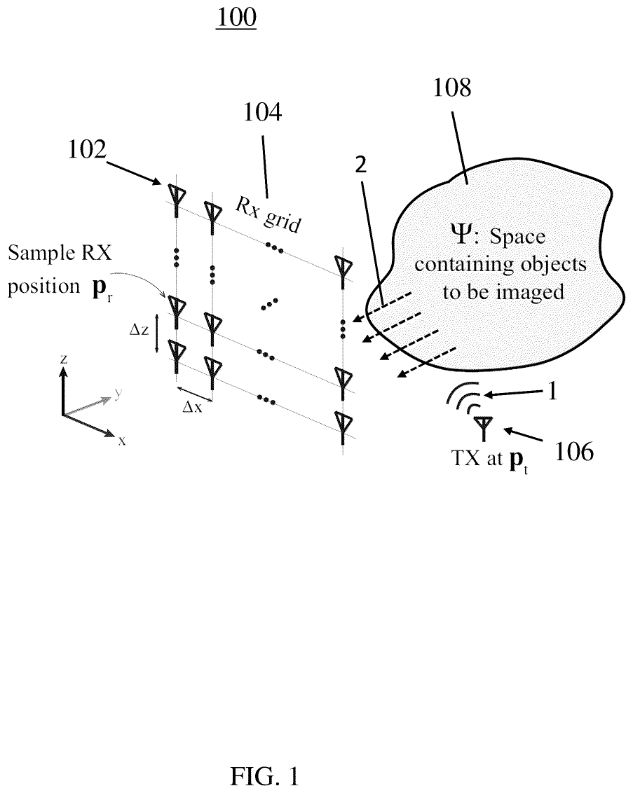

FIG. 1 is a schematic of a system 100 for imaging and sensing a space of interest using diffraction principles, according to some embodiments. In some embodiments, the system 100 includes one or more receivers/detectors 102 configured to receive and/or detect a signal 2 (hereinafter referred to as a “signal receiver” or RX), one or more transmitters 106 configured to send a signal 1 (hereinafter referred to as a “signal transmitter” or TX), and an imaging space 108 (Ψ) containing at least one object/entity to be imaged or sensed. In some embodiments, the imaging space is in 3D. In other embodiments, it can be in 2D.

In some embodiments, the system 100 comprises a plurality of signal receivers 102. The plurality of signal receivers 102 may be arranged in a grid 104, as illustrated in FIG. 1, or spatially distributed within and/or around the imaging space 108. In some embodiments, the grid 104 is a two-dimensional grid. Signal receivers 102 arranged in a grid 104 may be spaced apart in the x and z directions with Δx and Δz denoting the inter-receiver spacing in the x and z directions, respectively. The signal receiver(s) 102 may be stationary or movable. In some embodiments, the system 100 comprises a plurality of signal transmitters 106. The plurality of signal transmitters 106 may be spatially distributed within and/or around the imaging space 108 and/or spatially distributed around the signal receivers 102. In some embodiments, the signal transmitters 106 and the signal receivers 102 are co-located, while in others, they may be spatially separated (example of which is shown in FIG. 1)

As illustrated in FIG. 1, signals 1 from a signal transmitter 106 are transmitting in the imaging space 108—in other words the signal transmitter 106 is illuminating the imaging space 108. Signal 1 may also be described as an incident wave. In at least one embodiment, the signal 1 transmitted by the signal transmitter 106 is a radiofrequency signal. In some embodiments, the radiofrequency signal is a WiFi signal in a frequency range of up to 10 Hz. In other embodiments, the radiofrequency signal is a mmWave signal in a frequency range of 30-300 GHz. In some embodiments, the radiofrequency signal is a Bluetooth signal. In other embodiments, the radiofrequency signal is a cellular signal. The signal 1 interacts with the imaging space 108 and any objects/entities/humans located within the imaging space 108. Interaction with the imaging space 108 may transform the signal 1 into a complex signal 2 that comprises signals from background reflections (waves) and/or object based reflections (waves). In the example illustrated FIG. 1, the complex signals 2 are shown traveling in one direction. However, the complex signals 2 could travel in more than one direction depending on the makeup of the imaging space 108. Detection of the complex signals 2 by the one or more signal receivers 102 depends on the location of the signal receiver 102 relative to the path of the complex signal 2. Thus, there may be regions where complex signals 2 exiting the imaging space 108 are not detected by a signal receiver 102. Therefore, distributing signal receivers 102 and/or the signal transmitters 106 around the imaging space 108 may increase the likelihood of detecting of the complex signal 2 and/or reduce a number of blind regions.

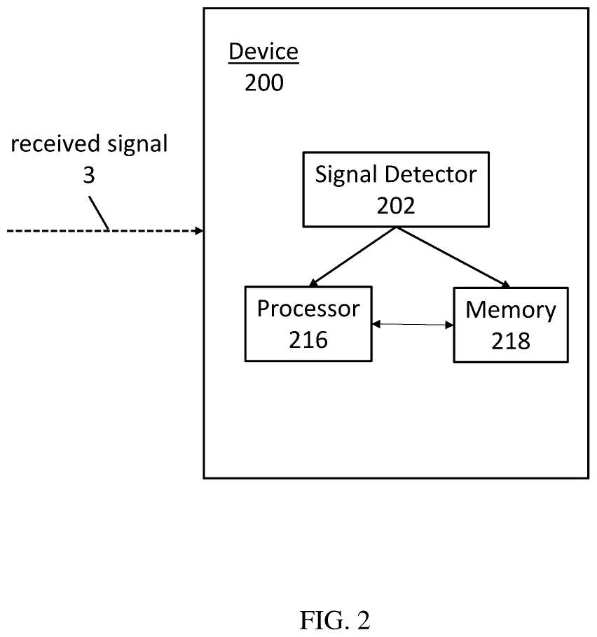

FIG. 2 is a schematic of a device 200 for edge detection, according to some embodiments. The device 200 includes a signal detector 202 configured to detect a received signal 3 and a processor 216 configured to execute instructions stored in memory 218. As illustrated in FIG. 2, the signal detector 202 may be configured to communicate with the processor 216 and/or memory 218. The processor 216 and memory 218 may be configured for unidirectional or bidirectional communication. As discussed above, the signal receiver 102 may be mobile. In some embodiments, the device 200 may be positioned in different locations within/around the imaging space 108 to detect complex signals 2. In one non-limiting example, the device 200 is a handheld device. In some embodiments, operations of device 200 may be distributed within the receiver units. For example, in some embodiments, there is a signal detector for each receiver but one memory unit and one process unit for all the receivers.

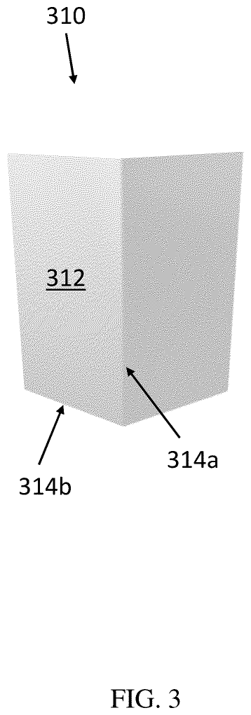

FIG. 3 is an illustration of an object 310 that may be located in an imaging space 108, according to some embodiments. The object 310 includes at least one surface 312 and at least one edge 314. As discussed above, the complex signal 2 may include object based reflections. Object based reflection comprise reflections off a surface 312 and reflections off an edge 314. As used in this application, an “edge” is a point that a signal wave sees as an edge. An edge may be described as a discontinuity of the object's surface normal direction. Edges (from a wave's perspective) include not only the visibly sharp points but also other surface points that have a radius of curvature smaller than the incident wave. For example, in some embodiments, a surface point that has a radius of curvature less than half of the wavelength of the incident wave is an edge. In other embodiments, a surface point that has a radius of curvature less than three-quarters (¾) of the wavelength of the incident wave is an edge. In other embodiments, a surface point with a curvature small enough as compared to the wavelength of the incident wave is considered an edge point.

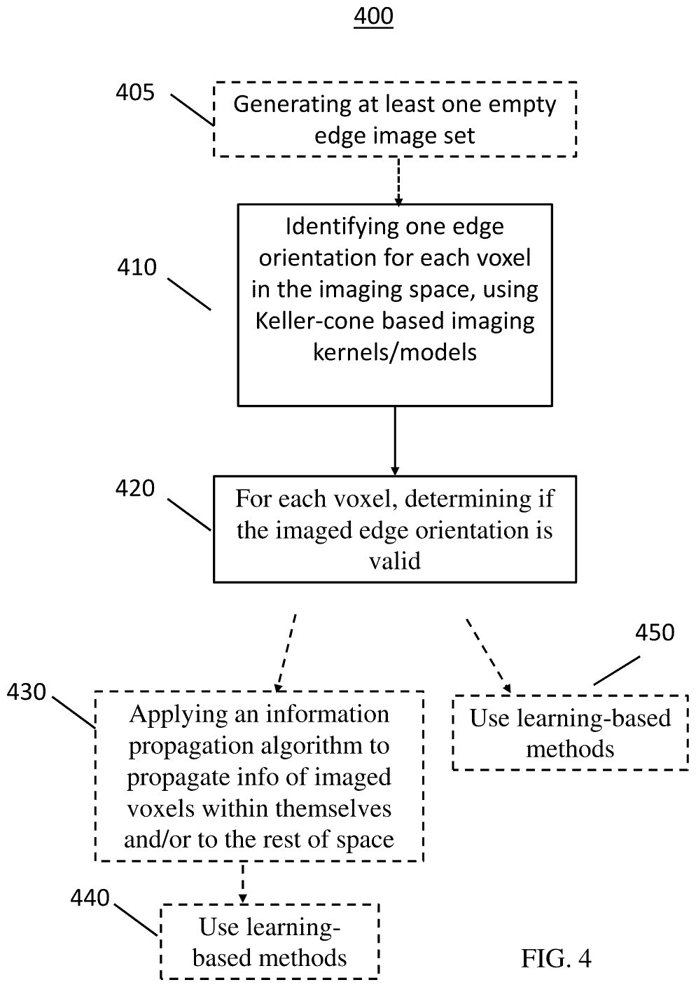

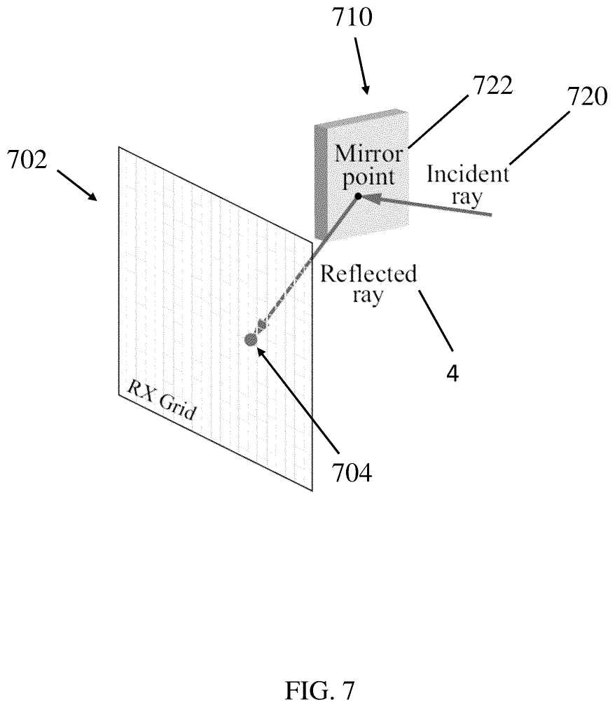

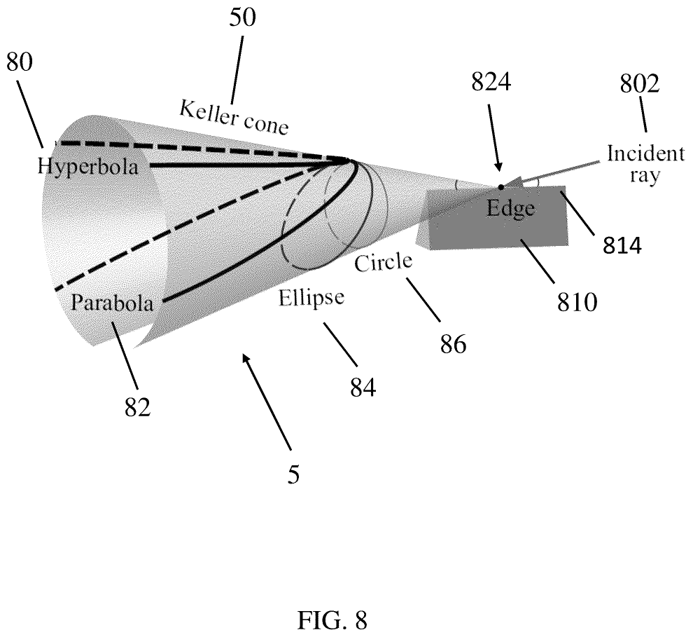

Reflection of an incident ray off a surface may differ from reflection of an incident ray off an edge, as illustrated in FIGS. 7 and 8. In at least one embodiment, the information provided by reflections off an edge may be utilized to sense or image the edge. FIG. 4 is a flowchart of a method 400 for edge detection and/or imaging, according to some embodiments. Dashed lines are utilized for optional steps: step 405, step 430, step 440, and step 450. In at least one embodiment, method 400 comprises step 410 and step 420. In some embodiments, method 400 comprise step 410, step 420, and step 430. In additional embodiments, method 400 comprises step 410, step 420, step 430 and step 440. In other embodiments, method 400 comprises step 410, step 420, and step 450. Method 400 may be utilized to generate an image of at least a part of the imaging space 108, to generate an image of an entity of interest, to generate an edge map, to generate an edge image, and/or to generate a trace of one or more edges in the imaging space of interest.

In at least one embodiment, method 400 uses the Geometrical Theory of Diffraction and the corresponding Keller cones to image one or more edges of an object or entity of interest. As discussed below in greater detail, when a wave is incident on an edge point, a cone of outgoing rays emerge according to the Keller's Geometrical Theory of Diffraction. As discussed above, reflections of an incident wave may differ. For example, in some embodiments, an incident wave 720 sees a point 722 on a surface as a smooth specular surface of an object 710 and a signal 4 comprising a single reflected ray/wave 4 is produced (FIG. 7) whereas when an incident wave 802 interacts with a point 824 on an edge 810, a signal 5 comprises a plurality of reflected rays forming a Keller cone 50 are produced (see e.g., FIG. 8). The intersection of the cone of outgoing rays with a receiver array, e.g., grid 104 of FIG. 1, may be used to trace (image) one or more edges in an imaging space corresponding to the imaging space 108. In at least one embodiment method 400 is utilized to image all or part of an object, or to image a plurality of objects. In some embodiments, method 400 is used to generate an edge trace/map of all or part of an object or a plurality of objects. In some embodiments, method 400 is used to perform sensing or context inference based on the information extracted at least in part based on edge interactions. In some embodiments, method 400 is used to perform any of the aforementioned sensing and imaging tasks through walls. In some embodiment, the object or objects of interest may be static, while in other they may be moving. In some embodiments, method 400 is used to sense or image everyday objects of entities. In some embodiments, method 400 is used to sense or image concealed entities. In some embodiments, method 400 is used to sense or image cracks and/or discontinuities in materials. In at least one embodiment, method 400 may be executed by a WiFi Reader. Method 400 may be utilized with one or more signal receivers 102, one or more signal transmitters 106, and combinations thereof. For simplicity, method 400 will first be described for a single (one) transmitter and the case of multiple transmitters discussed after.

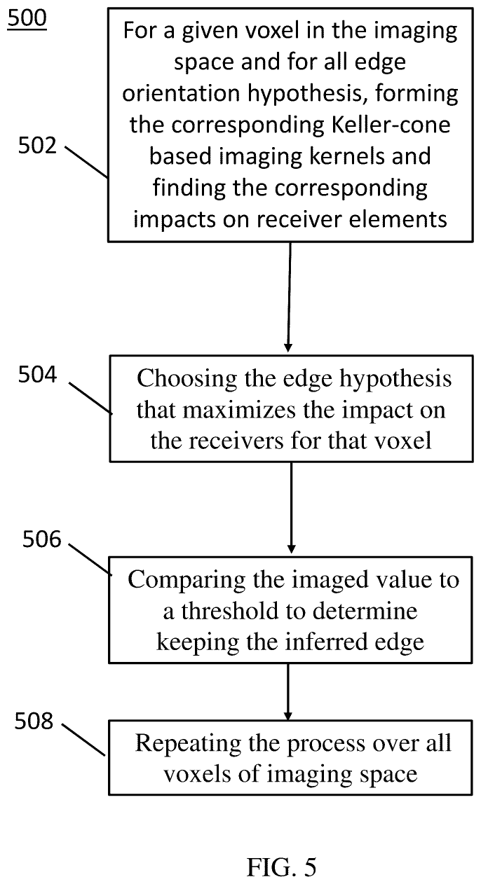

Optional step 405 comprises generating at least one empty edge image set. In some embodiments, step 405 comprises generating a set of empty voxels or pixels for the image space of interest. In some embodiments, each empty edge image set will be populated with voxels corresponding to an edge present or absent in the imaging space 108 after the execution of step 420. Step 410, described in more detail with respect to FIG. 5, comprises identifying at least one edge orientation for each voxel in the imaging space, using Keller-cone based imaging kernels, where a kernel is a function/model built based on Keller cones and/or diffraction principles, and identifying an edge orientation that maximizes the corresponding kernel. Briefly, the Keller-cone based imaging kernels may be used to reconstruct images of the imaging space 108 via at least in part imaging and/or tracing edges. Each reconstructed image comprises at least one voxel. In some embodiments, step 410 involves finding for each voxel in the imaging space of interest, the edge orientation that was most likely to cause the pattern observed on the receivers, using Keller-cone based modeling. In some embodiments, step 410 involves hypothesis testing to choose the most likely edge orientation for a given voxel, via searching a subset of possible edge orientations using a Keller-cone based kernel/model. The quantization over a subset of edge hypothesis can reduce the computational complexity of finding the optimum edge orientation, making it suitable when fast computation is needed. But the problem can be solved in the continuous edge domain as well, accordingly to some embodiments.

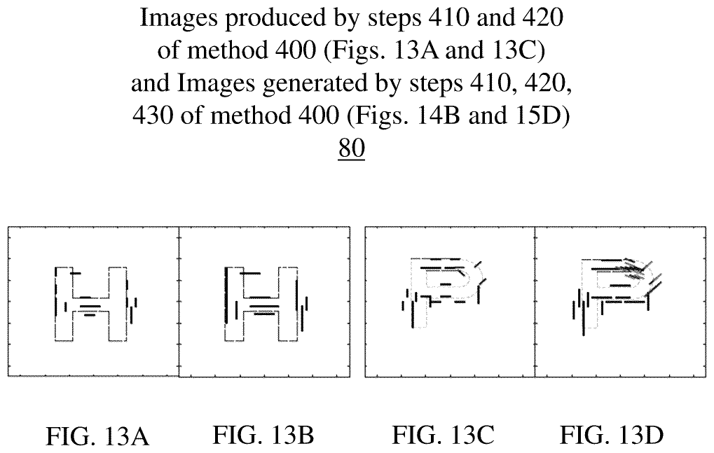

Step 420, comprises determining, for each voxel, if the imaged edge orientation is valid. In some embodiment, this is achieved via comparison of the impact of the resulting Keller cone on the receivers to a threshold. In some embodiments, other methods can be used for this determination. If the edge is determined not plausible for a voxel, based for instance on the currently-assessed impact on the receivers or based on other assessment, then no edge is declared for that particular voxel. Since all the points in the space of interest are not occupied by edge-like points, this step declares the points where edge-like points may be declared with a given desired confidence and further generates/traces an edge orientation for them. The output of step 420 produces a set of edge points for some or all the voxels in the imaging space for which an edge may be declared with high confidence. FIGS. 13A and 13C illustrate exemplary images produced at the completion of step 420.

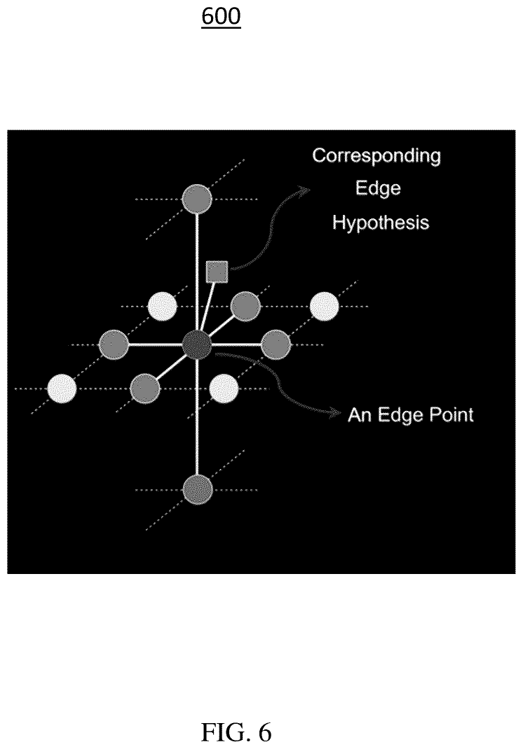

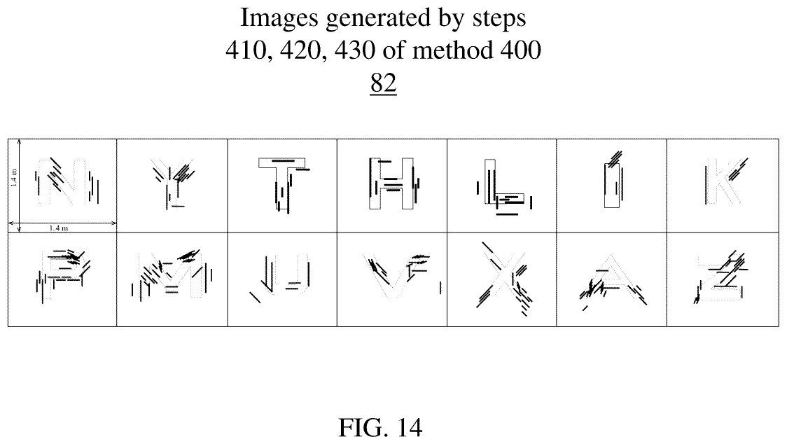

Optional step 430, described in more detail with respect to FIG. 6, comprises applying an information propagation algorithm to propagation information of inferred voxels throughout the imaging space, in order to improve the performance. In some embodiments, the space of interest is modeled as a graph. In some embodiments, an information propagation algorithm is used to exploit the natural dependency between different parts of natural scenes/entities. In some embodiments, Bayesian information propagation algorithms are used to propagate information of imaged voxels within themselves and/or to the rest of imaging space. In some embodiments, step 430 improves the image at the completion of step 420. FIGS. 13B, 13D and 14 illustrate exemplary images generated by applying a Bayesian information propagation algorithm to an image generated at the completion of step 420. FIGS. 13A-D show that if two imaged points belong to the same edge, the Bayesian network helps in connecting them, thus improving the imaging quality (compare FIG. 13A to FIG. 13B, and FIG. 13C to FIG. 13D). However, FIGS. 13A-D also show that the imaging results are also decent without applying step 430. The overall classification accuracy drops from 86.7% to 76.7%, without applying step 430 for one set of imaging results.

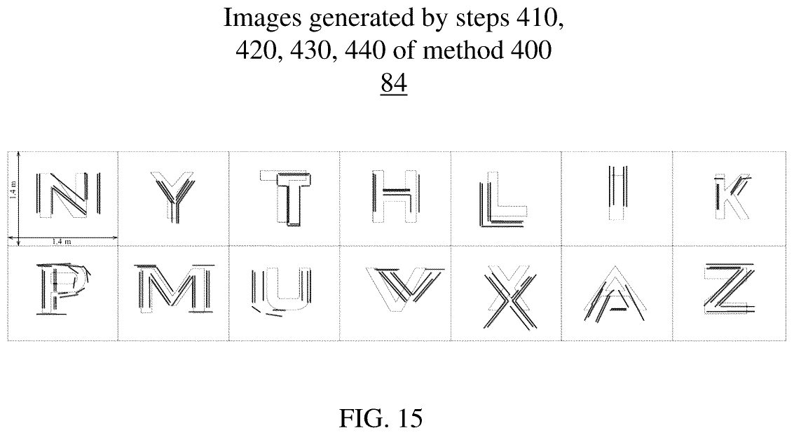

Optional step 440 and step 450 each comprise applying learning-based methods. In some embodiments, a machine-learning pipeline can be trained to improve the quality of the already generated image. In some embodiments, an existing machine learning-based pipeline can be used to improve the quality of the already-generated image. In some embodiments, an existing vision-based image improvement neural network (e.g., an image completion network, an image denoiser network, etc) is used to improve the imaging quality. In some embodiments, a classifier (existing or newly trained) is used to classify the imaged scene/object(s). In some embodiments, a classifier (existing or newly trained) is used to first classify the imaged scene and/or some of the object(s) within it, and then the classification output is used to further improve the image quality. In some embodiments, application of learning-based methods improves the quality of images generated at the completion of steps 410/420 or at the completion of steps 410/420/430. FIG. 15 illustrates images generated by applying a classifier to an image generated at the completion of steps 410/420/430 of method 400 and further improving the imaging quality based on the output of the classifier. In some embodiments, the output of the classifier is used to enhance the image quality by suggesting edges to improve the original edge image. An exemplary Hough Domain classifier that may be utilized in some embodiments for steps 440 and/or 450 is discussed below in greater detail to provide an example of steps 440/450.

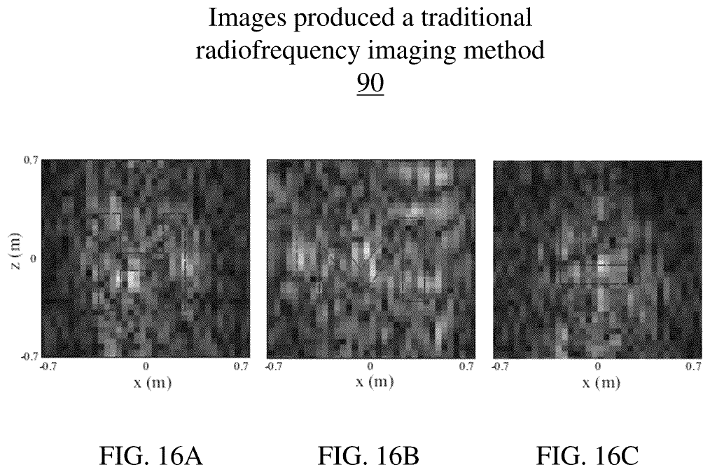

FIG. 16 illustrates images obtained by a typical imaging method. Imaging utilizing method 400 produces higher quality images than a typical imaging method, as can be seen by a comparison of FIG. 16 with FIGS. 13A and 13C (images produced at the completion of steps 410 and 420 of method 400), FIG. 14 (images generated at the completion of steps 410, 420, and 430 of method 400), and FIG. 15 (images generated at the completion of steps 410, 420, 430, and 440 of method 400. A comparison of FIGS. 13A and 13C with FIG. 16 shows that the quality of images generated by method 400 is better than a typical imaging method, even before applying the information propagation step 430. Method 400 may be utilized to sense and/or image different imaging spaces/environments/entities. Method 400 can be used for sensing both static entities and moving entities. Method 400 also performs robustly and consistently across different areas. One aspect of the robustness of method 400 is that it may be utilized to image area despite interference in the imaging space 108, such as movement near a signal receiver 102. In some embodiments, method 400 may be utilized to image an imaging space that experiences interference during up to 70% of the data collection process.

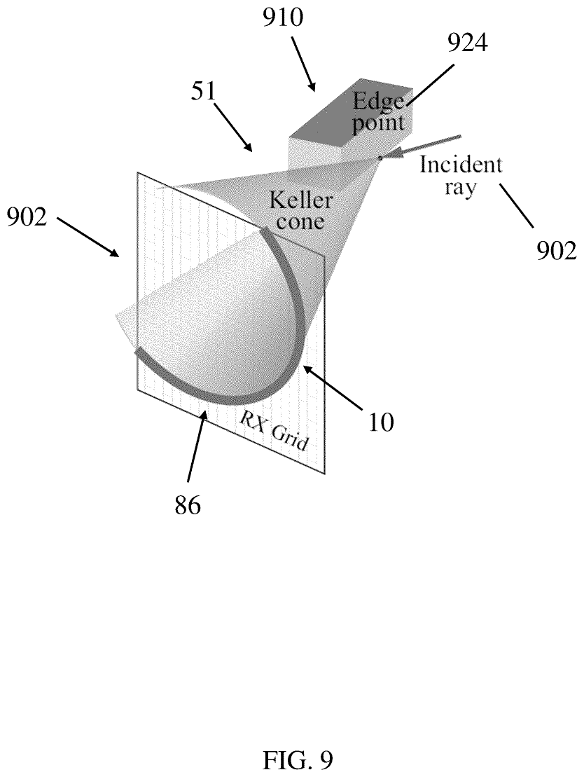

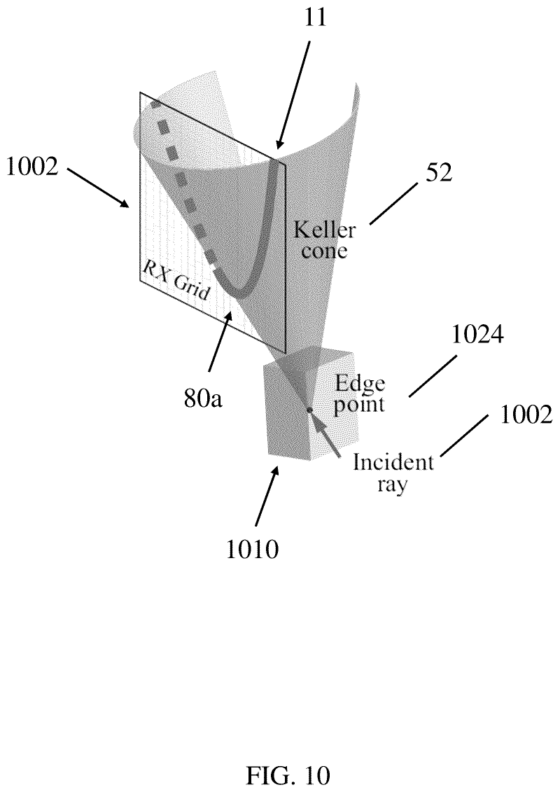

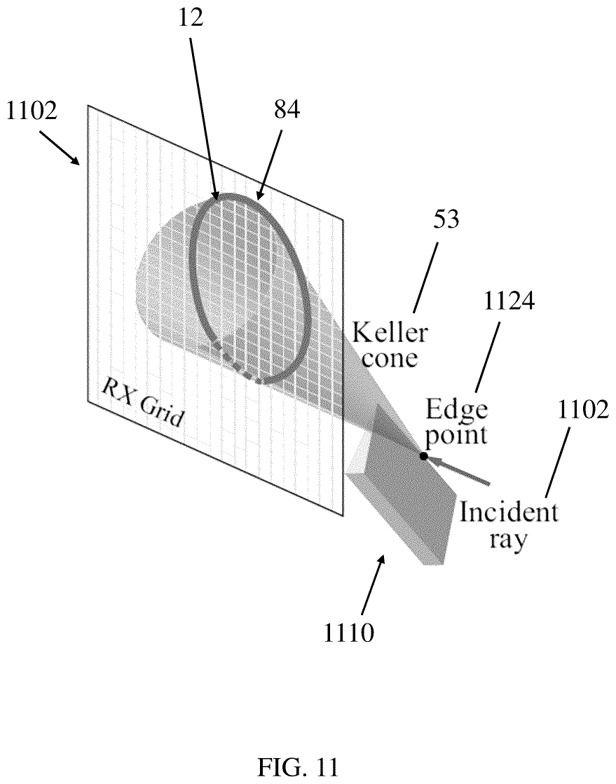

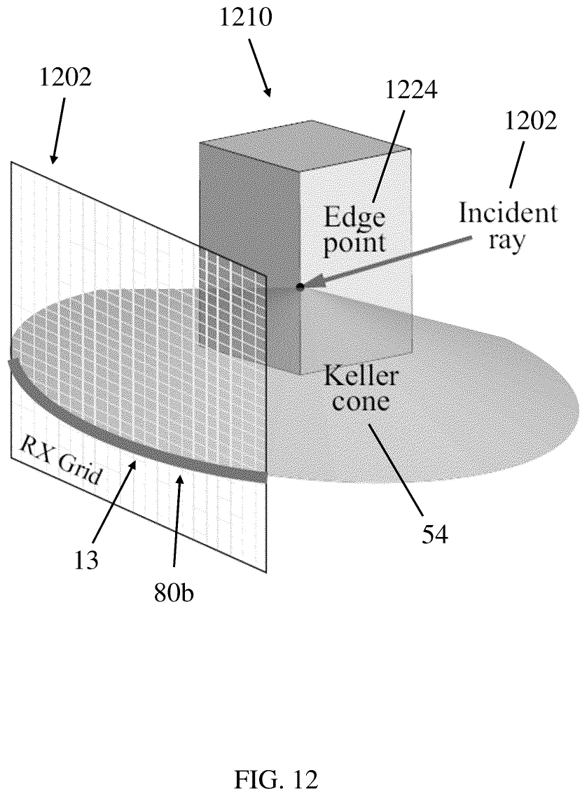

FIG. 5 is a flowchart of a method 500 for identifying at least one edge orientation for each voxel in the imaging space, using Keller-cone based imaging kernels/models and hypothesis testing that may be utilized for step 410, according to some embodiments. As discussed above, different types of waves are formed by an incident wave interacting with a point on a surface compared to a point an edge. Non-edge points 722 (henceforth referred to as mirror-like points can appear near-specular, only reflecting the signal 4 to one or a very small number of RX points 704 of receiver array 702, as illustrated in FIG. 7. Edge points, on the other hand, can provide vital information for imaging since they are visible to a much larger number of RX points at the corresponding conic section. An outgoing Keller cone leaving an edge point may impact the RX array. More specifically, as illustrated for example in FIG. 9, the signal receivers of an RX array 902 at the intersection of the RX plane and the corresponding cone 51 are the signal receivers that receive the signal power and thus “see” the impact of that edge point 924. Depending on the edge orientation, the angle of the incident wave, and the orientation of the RX array plane, the intersection of the Keller cone 50 with a RX array will result in different 2-D shapes, e.g., hyperbola 80, parabola 82, ellipse 84, or circle 86, formally referred to as conic sections, as shown in FIG. 8. FIGS. 9-12 show a few example cases of an incident wave interacting with different edges, the resulting Keller cones, as well as the resulting conic sections. At step 502 the corresponding conic impact of the Keller cone on the receiver(s) 102 is determined for a given voxel in the imaging space and for each edge orientation hypothesis. In some embodiments, following projection function is used for a given hypothesis and for a voxel in the imaging space of interest, in order to capture the impact of the resulting Keller cone:

$$I ( {p}_{m} , {ℋ}_{{ϕ}_{i}} ) = \vert {\sum }_{{p}_{r} ∈ R {X}_{{p}_{m}} ( {ϕ}_{i} )} \overline{P} ( {p}_{r} ) g ( {p}_{t} , {p}_{r} ) {g}^{*} ( {p}_{m} , {p}_{r} ) \vert \qquad ( 1 )$$

where I(pₘ, [symbol] _{ϕ}_{ᵢ}) is a measure of the projection of the received power measurements of the receiver elements onto the Keller-cone based imaging kernel that is generated for a voxel at pₘ under hypothesis [symbol] _{ϕ}_{ᵢ}; hypothesis [symbol] _{ϕ}_{ᵢ}=edge at pₘ makes angle ϕᵢ with the positive x-axis, where; ϕᵢ∈ΦRXₚ_{ₘ}(ϕᵢ) is a RX group of an edge with the orientation ϕᵢ at pₘ; P̅(pᵣ) is the power (squared magnitude) measurement of the received signal after background subtraction; and g(pₜ,pᵣ)g*(pₘ,pᵣ) are the corresponding Green's functions terms in the imaging kernel \hat{κ}, discussed below in greater detail. Eq. 1 may be described as a proposed model that is at least in part based on wave diffraction principles, for a given edge orientation. For instance, RXₚ_{ₘ}(ϕᵢ) is the footprint (conic intersection) on the receivers of an edge with orientation ϕᵢ at location pₘ, using Geometrical Theory of Diffraction and the corresponding Keller cone, according to some embodiments. An exemplary derivation of expression (1) is discussed below in in the section entitled “More details on proposed imaging approach.”

Step 504 comprises choosing an edge hypothesis [symbol] _{ϕ}_{ᵢ} that maximizes the proposed imaging kernel for that voxel. Once all the hypotheses [symbol] _{ϕ}_{ᵢ}_{∈Φ} are tested for the location pₘ, the most likely orientation for the edge at pₘ (if it exists) is represented by ϕ^{★} where

$${ϕ}^{★} ( {p}_{m} ) = {arg max}_{{ϕ}_{i} ∈ Φ} ℐ ( {p}_{m} , {ℋ}_{{ϕ}_{i}} ) \qquad ( 2 )$$

Step 506 comprises comparing the imaged value to a threshold to determine if the inferred edge is valid and should be kept or invalid and should be discarded. In some embodiments, this evaluation is done based on evaluating the impact of the found edge orientation on the receivers and judging if the impact is strong enough. In some embodiments, it can be determined if there is indeed an edge at pₘ (whose angle ϕ^{★} is dictated by Eq. 2), by considering a scaled, or normalized, version of I (Ī(pₘ)) (scaled to have a maximum of 1) represented by the following expression:

$$\overline{ℐ} ( {p}_{m} ) = \frac{ℐ ( {p}_{m} , {ℋ}_{{ϕ}^{★} ( {p}_{m} )} )}{{max}_{p ∈ Ψ} ℐ ( p , {ℋ}_{{ϕ}^{★} ( p )} )} \qquad ( 3 )$$

If no edge existed at location pₘ, the value of the normalized image Ī(pₘ) is low. Therefore, if Ī(pₘ) exceeds a threshold Iₜₕ, there is an edge at pₘ. This analysis may be used to populate an empty set generated at step 405 to generate a set of voxels in the image space for which an edge can be declared with high confidence:

$$𝒮 = \{ p ; \overline{ℐ} ( p ) > {ℐ}_{th} , p ∈ Ψ \} \qquad ( 4 )$$

where S is a set of high-confidence locations. For computational efficiency the set Φ used for ϕᵢ∈Φ can be small. For example, four (4) angles may be sufficient to determine the set of high-confidence locations S.

Step 508 comprises repeating steps 502, 504, and 506 for all voxels of the imaging space.

As noted above, methods 400 and 500 may also be utilized when multiple transmitters illuminate the imaging space 108. In general, having more than one TX can help by illuminating the imaging space 108 from different locations/perspectives. For example, part of the object area may receive a very weak signal from one TX. As another example, an object, illuminated by a TX, may be in a blind region of the RX array, which means that the scattering from this object may not reach the array, for the given TX location. Having multiple transmitters, thus, reduces the chance of such occurrences.

Consider the case where T TX are located at pₜ_{ₖ}, k=1, 2, . . . , T. An image may be constructed for each TX, according to some embodiments. For example, an Īₖ(pₘ) (Eq. 3) may be computed for each TX (for k=1, 2, . . . , T) and a corresponding set S (Eq. 4) may be generated for each TX (e.g., Sₖ for the k-th transmitter). The high confidence sets (S₁ . . . . Sₖ) may be aggregated into a superset that may be denoted as S_{U}=UₖSₖ. For overlapping Sₖ points, the highest Īₖ (Eq. 3) and its corresponding imaged angle (ϕ^{★}) will be the final value, according to some embodiments. Other methods may be used to fuse the result of imaging of the transmitters.

FIG. 6 is a graphical illustration 600 of an information propagation algorithm applied to the edge information of the high-confidence set S_{U}. As discussed above, after execution of steps 410 and 420, a set of voxels/locations in space with a relatively high confidence of having an edge and their edge angles are determined. Other voxels/locations in the imaging space 108 may still have edges that were undetected, for instance due to either being in a blind region or being overpowered by other edges that are closer to the signal transmitters 106. Furthermore, some of the inferred edges may still be noisy due to various challenges of such imaging tasks. Local dependencies in edges of real-life objects may be utilized to improve the overall imaging quality and/or to deduce information about the presence of edges in the rest of the voxels in the imaging space 108. For example, a graph, such as a Bayesian graph, can be used to model the dependencies in the imaging space 108 and further propagate the edge information of the high-confidence set S_{U} within itself and/or to the rest of the voxels. In some embodiments, the output of the Bayesian algorithm is a Probability Mass Function (PMF) for each voxel in space, describing the probabilities of this voxel over the |Φ|+1 states. The PMF, [symbol] (pₛ→γ) of length |Φ|+1, is given by the following expression:

$$ℙ ( {p}_{𝓈} ) = ( 1 - \overline{ℐ} ( {p}_{𝓈} ) , {\underbrace{0 , 0 , … , \overline{ℐ} ( {p}_{𝓈} ) , … , 0}}_{Non - zero only at {ϕ}^{★} ( {p}_{s} )} ) , \qquad ( 5 )$$

where the first element denotes the probability that pₛ has no edge, and the rest of the elements denote the probabilities that ps has an edge at different angles with the x-axis. Since pₛ is already associated with precisely one imaged angle ϕ^{★}(pₛ) (Eq. 2), the probabilities for all the other angles are set to 0.

The PMF may be utilized to construct the state probability vector of a high-confidence location pₛ∈S_{U}. For example, to describe the direction of information flow in the image, a tree-structured Bayesian graph with the high-confidence imaged edges as root nodes with the PMFs as described in Eq. 5 may be constructed, according to some embodiments. More specifically, each such node acts as a parent node and claims its 8 neighbors as children. If a neighboring pixel has already been claimed as a child of another pixel, the parent node skips it and claims the other neighbors, thus ensuring that each pixel has exactly one parent. The process then continues recursively, by having the new generation of pixels claim their own unclaimed neighbors as their children. Using the state probabilities of the roots [symbol] (pₛ→γ), as well as the conditional prior Ω, the information is then propagated via message passing from the roots to the leaf nodes. If the probability of having an edge at this voxel is greater than a threshold pₘᵢₙ, an edge is detected and its angle is declared based on the most probable angle state, as graphically illustrated in FIG. 6. In some embodiments, other information propagation methods that are not tree-based may be used to propagate the current information through the graph.

In some embodiments, priors are built to be used when propagating the imaged information throughout the graph. For instance, consider a 3×3 voxel neighborhood where a center voxel c is surrounded by 8 neighboring pixels n_{c1}, n_{c2}, . . . , n_{c8}, with n_{c1} representing the top left neighbor and the rest representing the other immediate neighbors in a clock-wise direction. The center voxel can either have no edge (i.e., it can be a mirror point or empty), or have an edge making an angle ϕᵢ∈Φ with the x-axis, amounting to a state space Γ of |Φ|+1 possible states. This produces the following conditional priors:

$$Ω ( {γ}_{b}^{[ {n}_{{c}_{j}} ]} \vert {γ}_{a}^{[ c ]} ) = \begin{matrix}Prob . that neighbor {n}_{{c}_{j}} has state {γ}_{b} \\ given center c has state {γ}_{a} ,\end{matrix} \qquad ( 6 )$$

where “state” refers to either having no edge, or having an edge with a specific angle. Then, given the states of the high-confidence points, and a graph describing the direction of information flow in the image, the conditional prior Ω serves as the driver to propagate the information from the high-confidence locations to the rest of the voxels. In some embodiments, conditional prior Ω is found by analyzing or calculating dependencies of voxels/entities in scenes via using existing image datasets. Images of FIGS. 14 and 15, for instance, are generated by calculating such priors using existing dataset of everyday objects.

### More Details on Proposed Imaging Approach

Different attributes of the received signals can be used for imaging. Exemplary attributes include a received signal strength (power), a received signal strength indicator (RSSI), a Channel State Information (CSI) measurement, a signal-to-noise ratio (SNR), a received channel power indicator (RCPI), a received signal, a phase measurement, or a phase measurement difference. In some embodiments, the power of the received signal is determined from another attribute of the received signal.

In some embodiments, the received signal power may be expressed as:

$$\overline{P} ( {p}_{r} ) \approx 2 ℛ \{ {\sum }_{{p}_{o} ∈ O {B}_{{p}_{r}}} Λ ( {p}_{o} , {p}_{t} , {p}_{r} ) g * ( {p}_{t} , {p}_{r} ) g ( {p}_{o} , {p}_{r} ) \} \qquad ( 7 )$$

where Λ(pₒ, pₜ, pᵣ)=\tilde{α}(pₒ, pᵣ)α*(pₜ, pᵣ)= and [symbol] is the real part of the argument.

In some embodiments, an imaging kernel may be expressed as:

$${\hat{κ} ( {p}_{t} , {p}_{m} , {p}_{r} ) = g ( {p}_{t} , {p}_{r} ) {g}^{*} ( {p}_{m} , {p}_{r} ) 〛}_{{p}_{r} ∈ R {X}_{{p}_{m}}} \qquad ( 8 )$$

where [symbol] is an indicator function that is one only if pᵣ∈RXₚ_{ₘ} and is zero otherwise, thus capturing the impact/footprint of the resulting cone on the receivers.

In some embodiments, an image at pₘ can be reconstructed by first projecting the RX power measurements on to the imaging kernel of Eq. 8 as follows:

$$I ( {p}_{m} ) = \vert {\sum }_{{p}_{r} ∈ R {X}_{{p}_{m}}} \overline{P} ( {p}_{r} ) \hat{κ} ( {p}_{t} , {p}_{m} , {p}_{r} ) \vert \qquad ( 9 )$$

This image reconstruction may be described as generating a theoretical model that is at least in part based on the wave interaction with edges or in general with the surfaces with small enough curvatures (curvatures smaller compared to the wavelength of the incident wave), and the resulting Keller cones.

In at least one embodiment, only grid points that carry information about the edge to be images, i.e., the RX grid points that belong to the Keller cone of the edge are used, instead of using all the RX grid points. In this example, this is achieved through the indicator function [symbol] ₚ_{ᵣ}∈RXₚ_{ₘ}. Utilizing only the RX grid points that belong to the Keller cone of the edge, instead of using all the RX points, may increase the signal to interference ratio. It is also noted that using a conic section that corresponds to the actual edge orientation at pₘ, may result in a much stronger signal value, thus increasing the value of I of Eq. 9.

Additionally, g(pₜ,pᵣ)g*(pₘ,pᵣ) is used as part of the image kernel \hat{κ} expression (Eq. 8) because it results in co-phasing when there is an object at pₘ.

In some embodiments, the edge orientation that maximizes I for a given position pₘ is used in order to infer an edge orientation (i.e. generate an imaged edge) at position pₘ. In some embodiments, for each point to be imaged, a set of edge orientations are tested for imaging, thus considering a discretized space for possible edge orientations as opposed to a continuous space. In the following discussion, we will discuss maximizing the projection function I over a discrete set of edge hypothesis possibilities. However, we note that function I can be equivalently searched for it maximum in the continuous domain. The shape and location of the RX group depend on the location of the TX (which is known) and the orientation of the edge is space, which is unknown. Based on the value of I at the corresponding elements of the test set, it can be decided if there is an edge at the corresponding point and if so, determine its orientation. For example, let Φ denote a discrete set of uniformly-spaced angles in [0, π), chosen based on a target angular resolution. [any additional info about “target angular resolution?] A series of hypotheses may be constructed. In some embodiments, an expression for the hypotheses is:

$${ℋ}_{{ϕ}_{i}} = Edge at {p}_{m} makes angle {ϕ}_{i} with the + ve x - axis , where {ϕ}_{i} ϵ Φ \qquad ( 10 )$$

For each edge hypothesis [symbol] _{ϕ}_{ᵢ} at the imaging location pₘ, the RX group of an edge with the orientation ϕᵢ at, denoted by RXₚ_{ₘ}(ϕᵢ), needs to be located. First, points belonging to RXₚ_{ₘ}(ϕᵢ) are identified—i.e., the set of RXₚ_{ₘ}(ϕᵢ) is characterized. A point pᵣ belongs to RXₚ_{ₘ}(ϕᵢ) if it satisfies the following expression:

$$〈 \frac{{p}_{r} - {p}_{m}}{‖ {p}_{r} - {p}_{m} ‖} + \frac{{p}_{t} - {p}_{m}}{‖ {p}_{t} - {p}_{m} ‖} , \hat{e} 〉 = 0$$

where ê is a unit vector along the edge axis, and [symbol] .,. [symbol] is the dot product of the arguments. Once the set RXₚ_{ₘ}(ϕᵢ) has been characterized, an edge image under hypothesis [symbol] _{ϕ}_{ᵢ} may be described by first using the projection expression (1) discussed above with reference to method 500:

$$I ( {p}_{m} , {ℋ}_{{ϕ}_{i}} ) = \vert {\sum }_{{p}_{r} ∈ R {X}_{{p}_{m}} ( {ϕ}_{i} )} \overline{P} ( {p}_{r} ) g ( {p}_{t} , {p}_{r} ) {g}^{*} ( {p}_{m} , {p}_{r} ) \vert \qquad ( 1 )$$

Then an edge hypothesis that maximizes Eq. 1 or a normalized version of Eq. 1 is chosen, according to some embodiments.

### Applying Learning-Based Methods to Improve Image Quality

In optional Steps 440 or 450 of FIG. 4, learning-based methods can be used to improve the imaging quality, according to some embodiments, as discussed earlier. In some embodiments, a machine-learning pipeline, including existing or newly trained components may be employed to improve the quality of a generated image. In some embodiments, a classifier may be used to categorize the imaged scene and/or objects, and its output may further enhance image quality in some embodiments. We next discuss one example where a classifier is used to classify the imaged objects and the output of it is further used to improve the imaging quality.

In at least one embodiment, a Hough Transform is utilized to convert edges in the x-z plane to points in the ρ-η domain (or Hough domain), where ρ is the perpendicular distance of the edge line from the origin (taken to be the bottom-left corner of the image), and η is the angle of the edge. Segments belonging to the same extended line are represented by the same point in the ρ-η domain, implying that even a sub-segment of the actual edge is as good as the whole edge. In some embodiments, generating a Hough Transform Classifier for use with method 400 (e.g., steps 450 or 440) comprises retraining an existing object classifier using the Hough domain representation. In other embodiments, generating a Hough Transform Classifier for use with method 400 comprises training a 3-layer Fourier convoluted neural network (FCNN).

In some embodiments, the FCNN is trained with approximately 40,000 parameters. A training set is utilized to train the FCNN. The training set selected may depend on the objects to be imaged and classified. For example, to image letters a STEFANN font dataset, which has ˜900 uppercase font families for each of the 26 letters of the alphabet (all contour-based), may be utilized. Other training sets targeted to the objects expected in the imaging space 108 may be utilized. In some embodiments, the training dataset may be represented in the Hough domain, by using the Line Segment Detector (LSD) algorithm to efficiently extract line segments from the fonts in the dataset, and further generate a 2-D histogram of the corresponding ρ-η domain representation for each training data point. The range of ρ may be scaled linearly ([ρₘᵢₙ, ρₘₐₓ]→[0, 1]) to make the network invariant to shifting of the origin and 64 buckets may be utilized for the corresponding axis of the histogram. The buckets for the η axis set may be set as the 8 equispaced angle hypotheses. This produces a training dataset consisting of a total of 23,478 2-D histograms, each with a dimension of 64×8. Each histogram may be translated to a vector in [symbol] ⁵¹² and the vector, with its categorical label, may be fed to a shallow 3-layer FCNN classifier for training. The training process may be repeated across different random seeds to improve the generalizability of the classifier. Once trained, vectorized Hough domain histograms for the edge images generated by steps 410 and 420 of method 400 may be inputted into the Hough Transform Classifier for classification. In some embodiments, the output of the classifier is further used to improve the imaging quality. For instance, in some embodiments, the training dataset item of the predicted class that is perceived the closest to the initial input edge image is chosen and the original image is improved using this chosen item. For instance, in some embodiments, whenever there exists a point in the same location for both, the edge of the chosen item is overlayed on top of the original imaged edge.

### RF Field Programming

RF Field programming may be utilized for shaping the RF field, or for focusing on one or more directions/points in space. However, general RF field programming or even simultaneous focusing on multiple directions/points in space has remained a considerably challenging problem. Most work use very complex and costly element design, rely on exotic antenna designs and specialized RF component factors, and lack real-world environment testing. Some other work consumes too much power, for example utilizing phased-array antennas. In contrast, the RF field programming and/or focusing systems and methods described herein do not require specialized and/or expensive equipment and can be implemented as a passive system, i.e., does not need any self-powered components or electronics. Further the systems and methods described herein have been tested in real-world environments, as discussed in further detail in the paper entitled “I Beg to Diffract: RF Field Programming with Edges” published in The 29^{th} Annual International Conference on Mobile Computing and Networking (ACM MobiCom '23), incorporated by reference in its entirety. The RF field programming systems and methods described herein exploit diffraction phenomenon, for instance, the Geometrical Theory of Diffraction (GTD). As discussed below in greater detail, an RF field programming system disclosed herein may utilize diffraction-inducing components as “control knobs” and change the characteristics of these individual components to control the resulting diffraction-based fields and thereby generate a desired collective field accordingly.

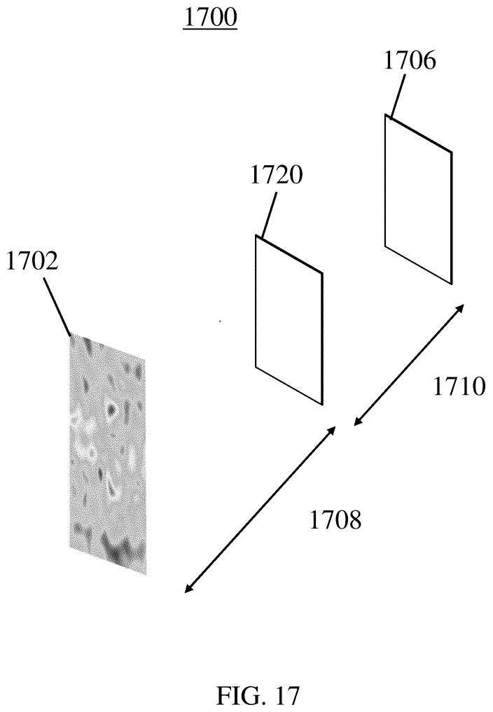

FIG. 17 is a schematic of a system 1700 for RF field programming, according to some embodiments. In some embodiments, an example of which is shown in FIG. 17, the system 1700 for RF field programming includes at least one transmitter (TX) 1706 positioned a distance 1710 away from RF diffraction element 1720. In other embodiments, the TX 1706 can be in other locations in the space. In some embodiments, more than one transmitter may be present. In at least one embodiment the TX 1706 transmits a radio wave signal. In some embodiments, the radiofrequency (RF) signal may be a WiFi signal. In some embodiments, the RF signal is a sub-6 GHz signal. In other embodiments, the radiofrequency signal may be a mmWave signal in a frequency range of 30-300 GHz. In other embodiments, the signal is a Bluetooth signal. A sample generated RF field 1702, positioned a distance 1708 away from the RF diffraction element 1720, illustrates the resultant RF field generated in response to the interaction between the radio wave signal generated by the TX 1706 and the RF diffraction element 1720. In this way, RF diffraction element 1720 can be designed and/or dynamically modified to generate the desired RF field 1702. While FIG. 17 shows a sample desired RF field 1702 in a 2D plane, system 1700 is used to generate desired RF field 1702 over a 3D space. In some embodiments, system 1700 is used for multi-beam focusing, i.e., to generate strong beams in a number of desired directions or locations in space. In some embodiments, the TX 1706 may be fully or partly co-located with the RF diffraction element 1720.

In general, the RF diffraction element 1720 is comprised of one or more components (i.e., entities) that interact with the RF signal and cause the RF signal to diffract. The collective of the diffracted RF signals—via constructive and destructive interference-will result in variations in magnitude of the RF field at points in 3D space. In this way, the RF diffraction element 1720 can be utilized to provide RF field programming. As described in more detail below, the RF diffraction element 1720 can be designed to generate a desired RF field 1702 or the RF diffraction element 1720 can be dynamically modified via modification of the elements that cause diffraction of the RF signal to generate a desired RF field 1702. In some embodiments, the RF diffraction element is planar and includes a plurality of components (e.g., edges) positioned along the plane. In other embodiments, the RF diffraction element 1720 is three-dimensional and includes a plurality of components for interacting with the RF signal at various points in 3D space. In some embodiments, the RF diffraction element 1720 can be distributed over the space. As discussed in more detail below, in some embodiments the components are designed and fixed in place to generate a desired RF field based on the known position of the TX 1706 and the desired RF field 1702. In other embodiments, the components of the RF diffraction element 1720 may be dynamically modified/changed during operation to selectively modify the RF field 1702. In some embodiments, the components of the RF diffraction element 1720 are described as edge elements (e.g., elements that are thin thus causing edge diffraction). Such edge elements will interact with the incoming RF signals according to the Geometrical Theory of Diffraction (GTD) to generate Keller cones. Other components that cause diffraction of the RF signal may be utilized to generate the desired RF field 1702 (i.e., programmed RF field 1702). For example, other types of components that may be utilized include thin plates, wedges, dents, corrugated surfaces, material discontinuities, or combinations thereof. Different geometries for the component may cause a different type of interaction or diffraction pattern with the incoming RF signal, such as edge diffraction, tip diffraction, creeping ray diffraction, lateral ray diffraction and/or slit diffraction. Thus, the components may be described as diffraction inducing components. In some embodiments, the RF diffraction element 1720 may have hybrid design, consisting of a mixture of elements that cause diffraction and elements that may not cause diffraction.

In at least one embodiment, the TX 1706 is configured to transmit a radio wave. For example, the TX 1706 may be a WiFi transmitter. The TX 1706 has a location that may be described as a point x_{src}∈ [symbol] ³. In at least one embodiment, the TX 1706 is configured to be behind the diffraction element 1720, thus directing a signal wave towards the RF diffraction element 1720. The TX 1706 may be a directional transmitter or an omnidirectional transmitter. In some embodiments, the signal wave is a radio wave. As discussed below in greater detail, interactions of the signal wave with the components of the RF diffraction element 1720 causes diffraction of the RF signal that may be utilized for programming the RF field (i.e., modifying the intensity at various points). For example, in some embodiments, the RF diffraction element 1720 includes a plurality of edges configured to diffract the incoming RF signal and generate Keller cones. Modifying the orientation/position of the plurality of edges allows the RF field 1702 to be programmed as desired. In some embodiments, the sets of components may be described as control knobs. In some embodiments, the RF diffraction element 1720 may be positioned between the TX 1706 and the desired RF field 1702. In other embodiments, the TX 1706 may be positioned elsewhere in the space, such as on the same side as of the RF diffraction element 1720. In at least one embodiment, the position of the TX 1706 may be located at the origin of the coordinate system and the RF diffraction element 1720 may be positioned in the X-Z plane at y=yₛ. In some embodiments, the RF diffraction element 1720 is a collective of non-self-powered, referred to here as passive elements. In other embodiments, it may be a hybrid of self-powered and non-self-powered elements. If the RF diffraction element 1720 includes at least some self-powered elements, no TX may be needed outside in some embodiments.

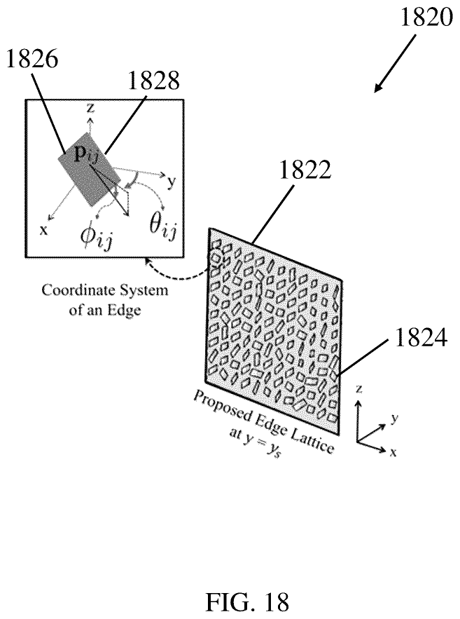

FIG. 18 is a schematic illustrating one embodiment of an RF diffraction element 1720 of FIG. 17, shown as element 1820, that utilizes components in the form of edges or edge elements 1824 configured to interact with the RF signal. In the example illustrated in FIG. 18 the RF diffraction element 1820 is a 2D structure. However, the RF diffraction element may also be a 3D structure. In some embodiments, a plurality of 2D edge lattices is arranged to form a 3D structure. In some embodiments, the RF diffraction element 1820 includes a plurality of edge elements 1824 and a support 1822. In one embodiment, the plurality of edge elements 1824 are arranged in a lattice. In some embodiments, the edge elements 1824 are distributed over the 3D space, not necessarily forming a lattice.

In at least one embodiment, the plurality of edge elements 1824 are arranged in an N×N array. The position of an edge element in an array may be described as pᵢⱼ∈ [symbol] ³ where i is the row and j is the column of the array. The orientation of an edge element 1824 at position pᵢⱼ may be described by an azimuth angle θᵢⱼ and an elevation angle ϕᵢⱼ measured relative to the outbound surface of the support 1822, as illustrated in the inset of FIG. 18.

The size of the array may be adjusted depending on the desired focusing quality/gain. For example, a smaller array may provide a coarser focus while a larger array may provide stronger and finer focusing. Thus, for a given number of focus points, the higher the required focusing gain, the larger the array of edge elements becomes. The size of the array may also be adjusted based on the number of focal points. For example, to achieve a given performance quality as the number of focal points increases, the minimum number of needed edge elements in the array increases.

As shown in the inset of FIG. 18, the exemplary edge elements 1824 each have a width 1826, a length 1828, and a thickness (not shown). In some embodiments, the edge elements 1824 are thin plates. In one embodiment, the dimensions of the edge element 1824 (width, length, and thickness) are such that the element is thin enough so that the interaction of the edge element 1824 with the incoming wave results in a non-negligible diffraction phenomenon and/or that the diffraction is the dominant phenomena. In some embodiments, the thickness of an edge element 1824 is small. In some embodiments, the thickness of an edge element 1824 is less than 1 mm. An edge element 1824 has an aspect ratio (length:width). In one aspect, a large aspect ratio (length much longer than the width) may ensure that diffraction off the edge is the dominant mode of electromagnetic interaction. In another aspect, for a given width, as the length becomes longer, the spacing between adjacent elements in an array is larger so that there is sufficient space for the edge element to rotate to any given angle. Stated another way, the dimensions of the edge element 1824 may determine the inter-element spacing of the plurality of edge elements of the RF diffraction element. A smaller inter-element spacing may result in a greater percentage of incident energy that is passing through the RF diffraction element 1820 that being intercepted by the edge elements 1824. The dimensions of edge element 1824 can be designed to balance these considerations. For instance, if the edge element 1824 is too wide, there is no prominent edge. If the edge element 1824 is too long, but too thin, there is less energy intercepted by the RF diffraction element 1820. In some embodiments, an aspect ratio is 2:1 is a non-limiting example of an aspect ratio that balances these considerations.

The wavelength (λ) of the wave transmitted by a transmitter, such as TX 1706, may be utilized to determine a desired aspect ratio. In some embodiments, the edge element 1824 has a length 1828 equal to λ/2 and a width 1826 equal to λ/4 to realize a 2:1 aspect ratio. Thus, as an example, for a 5 GHz signal, the edge elements may be 3 cm×1.5 cm.

Each edge element interacts with the RF signal according to the Geometrical Theory of Diffraction, resulting in a Keller cone. The collective of these elements are then used to program the RF field to generate a desired field. In some embodiments, the characteristics of these edge elements (e.g., orientations, locations, other properties) are modified, in order to change their resulting Keller cone patterns and thus collectively create the desired field.

The support 1822 may be configured to maintain the plurality of edge elements 1824 at a desired location and orientation. For example, the support 1822 may include a plurality of slots each sized to receive and secure an edge element 1824 at the desired location and orientation. To secure the edge element 1824 at the desired orientation, the slots may extend into and/or through the support 1822 at an angle to the outbound surface of the support 1822 and sized to receive a side of the edge element 1824 with width 1826. In some embodiments, the support 1822 is non-reconfigurable, i.e., the orientation of the edge elements 1824 is static. An RF diffraction element with a reconfigurable support may be described as a static RF diffraction element. In other embodiments, the support 1822 is reconfigurable, i.e., the orientation of the edge elements 1824 may be modified. For example, a reconfigurable support may include actuators that may adjust the orientation of one or more of the edge elements. As another example, a reconfigurable support may include a “smart material” that responds to an external stimulus. For example, a smart material may reversibly contract upon application of heat and/or light. In some implementations, a reconfigurable support may be utilized for dynamic focusing. In some embodiments, a controllable/adaptive phased array antenna may be used in conjunction with a non-reconfigurable RF diffraction element, to create reconfigurability. In some embodiments, the phased array antenna may be inserted between the transmitter and the RF diffraction element. In some embodiments, the reconfigurability can be achieved through manually changing the characteristics such as the orientations of the edge elements.

In at least one embodiment, the support 1822 is formed of a material that does not reflect the signal waves and the edge elements 1824 are manufactured from a material that reflects signal waves. For example, the support 1822 may be formed of a plastic material. Non-limiting examples of a plastic material that may be utilized for support 1822 is acrylonitrile butadiene styrene (ABS) and/or liquid crystal elastomers (LCEs). ABS may be utilized for a non-reconfigurable RF diffraction element. LCEs may be utilized for a reconfigurable RF diffraction element. In some embodiments, an additive manufacturing method is utilized to manufacture the support 1822. For example, a 3D printer may be utilized to manufacture the support 1822. For example, a conductive material may be utilized to manufacture edge elements 1824. One non-limiting example of a material that may be utilized to manufacture plurality of edge elements 1824 is steel. As mentioned above, one benefit of the disclosed system is the low cost. A 3 cm×1.5 cm steel plate edge element may cost about 7 cents.

In other embodiments, other geometries/shapes may be utilized in place of or in conjunction with the edge elements described with respect to FIG. 18 to generate the desired RF field. As mentioned for FIG. 17, the RF diffraction element 1720 can include any collection of elements where at least some elements exhibit non-negligible/dominant diffraction phenomena. FIG. 18 discussed some possible embodiments for the diffraction element 1720.

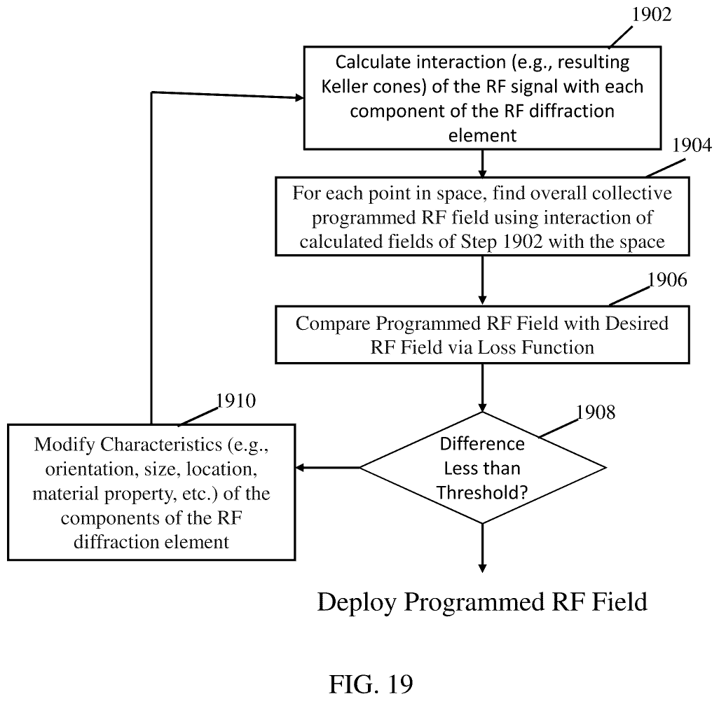

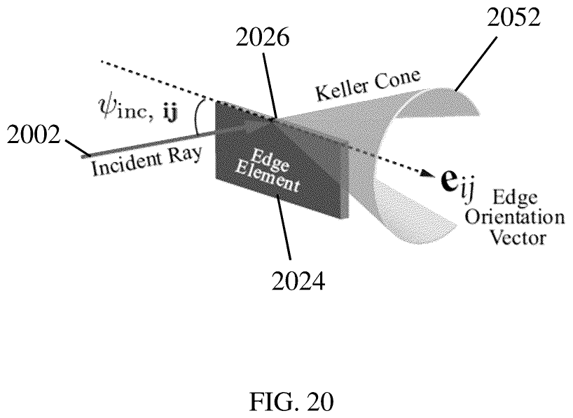

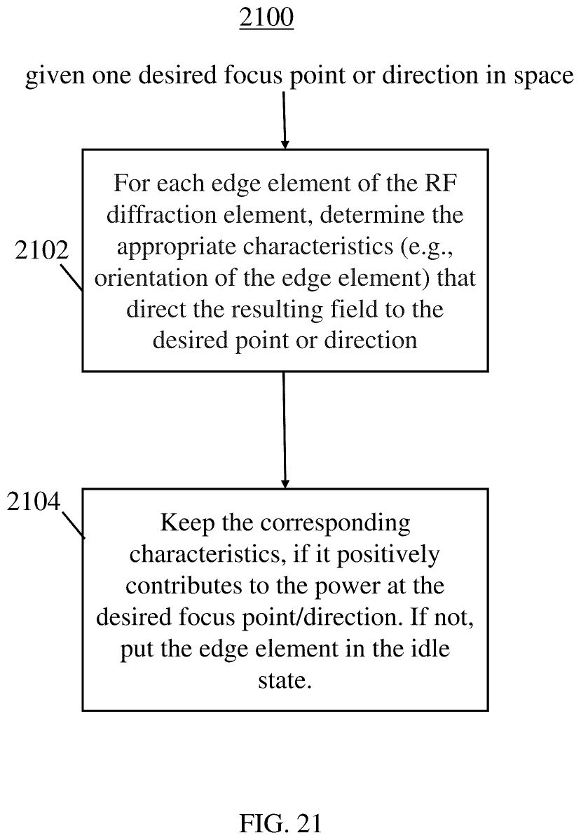

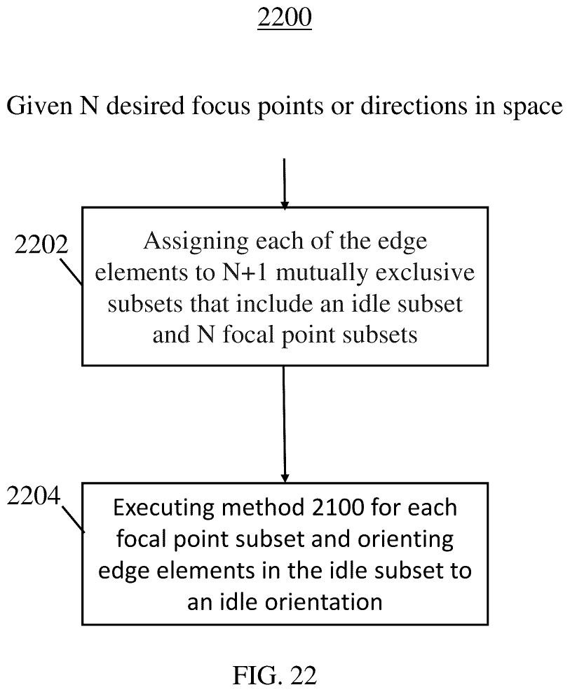

FIG. 19 illustrates a flowchart of an exemplary method 1900 to program the RF field according to some embodiments. In at least one embodiment, method 1900 is utilized to modify the characteristics (e.g., orientations, positions, etc.) of at least some of the entities of the diffraction element 1720 of FIG. 17, in order to affect the resulting diffraction phenomena and collectively program the field to a desired one. In one embodiment, method 1900 is used to orient the plurality of components, like the edge elements 1824 described with respect to FIG. 18, to focus on a single point/direction (single point/direction focusing, discussed below with respect to FIG. 21), to beam-form with respect to a plurality of points/directions (multi-point/direction focusing, discussed below with respect to FIG. 22), or to generate any desired RF field pattern over a 3D space. In other embodiments, the diffraction element 1720 may include other types of elements that result in a diffraction-based wave interaction, as discussed for FIG. 17. In some embodiments, the Geometrical Theory of Diffraction (GTD), which models the scattered field off an edge as a Keller Cone, may be utilized to generate a pattern for the plurality of edge elements. FIG. 20 illustrates an example of a Keller cone 2052 that may be generated by an incident ray 2002 impacting an edge element 2024 at point 2026. A point lies on the Keller cone 2052 when the angle of incidence ψ_{inc} is equal to the angle between the edge element orientation vector eᵢⱼ and a vector from the edge element location ij to the point (not shown in FIG. 20). Both the edge element orientation vector eᵢⱼ and the angle of incidence may be determined by the azimuth angle θᵢⱼ and an elevation angle ϕᵢⱼ of the edge element 1824 (shown in FIG. 18). For example, the edge element orientation vector eᵢⱼ may be represented by the equation eᵢⱼ=cos ϕᵢⱼ sin θᵢⱼ, cos θᵢⱼ cos ϕᵢⱼ, sin ϕᵢⱼ and the angle of incidence may be represented by the equation

$${ψ}_{inc , ij} = arc cos \{ \frac{< {p}_{ij} - {x}_{src} , {e}_{ij} >}{‖ {p}_{ij} - {x}_{src} ‖ ‖ {e}_{ij} ‖} \} ,$$

where <⋅,⋅> represents the inner product and x_{src} is the location of the TX. Similar analysis may be utilized with respect to other geometries based on the principles of GTD.

With respect to an RF diffraction element 1720 that is comprised of a plurality of edge element (an example of which is shown in FIG. 18), because the angle of the cone is equal to the angle of incidence of the wave generated by the TX, the direction and spread of the Keller cone may be controlled by adjusting the orientations of the edge elements. Thus, the edge elements via their respective orientations may be described as “control knobs” that may be utilized to focus an incoming signal onto at least one point or to disperse an incoming signal in a desired pattern.

Turning to FIG. 19, a method 1900 for determining the characteristics of the diffraction-inducing components (e.g., orientations of the edge elements) in order to generate a desired RF field is illustrated by a flowchart. Step 1902 of method 1900 includes calculating interaction of the RF signal with each component of the RF diffraction element. For example, using the example of edge elements illustrate in FIG. 18, a Keller cone is generated for each of the plurality of edge elements based on the interaction of the RF signal with the edge, dictated by the Geometrical Theory of Diffraction For other types of components that may be utilized as part of the RF diffraction element 1720 (e.g., wedges, dents, corrugated surfaces, material discontinuities, or combinations thereof), a resulting field is generated for each individual component following the underlying diffraction principle.

At step 1904, for each point in space within the area defined by the desired RF field, the RF fields calculated at step 1902 for each individual component of the diffraction element are interacted with the environment to generate the overall collectively programmed RF field. In some embodiments, this is modeled as a summation of the individual fields. For example, at step 1902 a plurality of Keller cones may be calculated based on interaction of the RF field with a plurality of edges. The sum of the contributions from these diffracted Keller-cone based RF signals at each point in space defines the programmed RF field based on the characteristics of the RF diffraction element, according to some embodiments. In some embodiments, simulators may be used to generate the overall collective field.

At step 1906, the programmed RF field calculated at step 1904 is compared with a desired RF field via a loss function. If the resulting difference is less than a threshold provided at step 1908, indicating that the programmed RF field resembles the desired RF field, then no additional modifications are required of the RF diffraction element and the system is deployed. If the difference is not less than a threshold, then at step 1910, one or more characteristics of the RF diffraction element is modified and the process continues at step 1902. Examples of characteristics of the RF diffraction element that may be modified include orientation, size, location, material property, etc. of the components of/entities within the RF diffraction element. With respect to the example utilizing a plurality of edges, the orientation and/or position of one or more of the edges may be modified.

Modification of the characteristics of the RF diffraction element in step 1910 may take a variety of forms. In some embodiments, mathematical modeling or algorithmic techniques are used to modify the characteristics. For example, in some embodiments the diffraction element may include random changes to the characteristics of the RF diffraction element (e.g., trial and error) to find the characteristics that generate the desired RF field. In other embodiments, modifying the characteristics of the RF diffraction element includes a search of a high dimensional space using techniques such as simulated annealing or other optimization techniques. In other embodiments, machine learning techniques may be utilized to structure the search for the desired RF field.

FIG. 21 is a flowchart of a method 2100 to find the appropriate characteristics (e.g., orientations, positions) of the components of the RF diffraction element for single-point/direction focusing, according to some embodiments. In the following explanation for FIG. 21, edge elements are utilized as the component that interacts with the RF signal, but in other embodiments other types of diffraction-inducing components may be utilized. At step 2102, each edge element is analyzed with respect to the desired single point or direction in space, in order to determine the characteristics of the edge element that will direct the RF signal to the desired point/direction. For example, the Keller cone generated in response to the interaction of the RF signal with an edge is analyzed to determine the edge orientations that will direct the resulting Keller cone to the desired point/direction. In some implementations, a first edge element has an orientation that positively reinforces a direct path from the transmitter to the desired target point and a second edge element does not have an orientation that positively reinforces a direct path from the transmitter to the desired target point. In some embodiments, determining if an orientation positively contributes to the power at the desired focus point/direction involves mathematical modeling. For instance, mathematically, this determination may be represented by the following equation:

$$ℛ \{ {F}_{cone}^{*} ( f , {p}_{ij} , {e}_{ij} ) {F}_{scr} ( f , {x}_{scr} ) \} > 0 \qquad ( 11 )$$

where [symbol] {⋅} denotes the real part of the argument; F_{cone}*(f,pᵢⱼ,eᵢⱼ) is a complex conjugation of the path on the Keller cone to a target point f from an edge element that is located at point pᵢⱼ and has an edge orientation vector eᵢⱼ; and F_{scr}(f,x_{scr}) denotes the direct path field from the transmitter located at point x_{scr} to the target point f without a RF diffraction element. In some implementations, this assumes that the transmitter is located at the origin of the coordinate system.

At step 2104, if the analyzed edge can positively contribute to the power at the desired focus point/direction, then one such determined orientation of the edge is maintained. If the analyzed edge negatively contributes to the power at the desired focus point/direction, for any considered orientation, then the orientation of the edge is modified to an idle orientation, which is an orientation that minimizes the impact/diffraction of the RF signal in response to an interaction with the edge. In some embodiments, the idle orientation is eᵢⱼ=[0, 0, 1]. In some embodiments, a determination that an edge should be in an idle orientation may include removal of the edge element rather than changing the orientation to an idle orientation. Overall, the method described in FIG. 21 may be utilized to design/program the RF diffraction element 1720 to focus the RF field on a single direction/point in space.

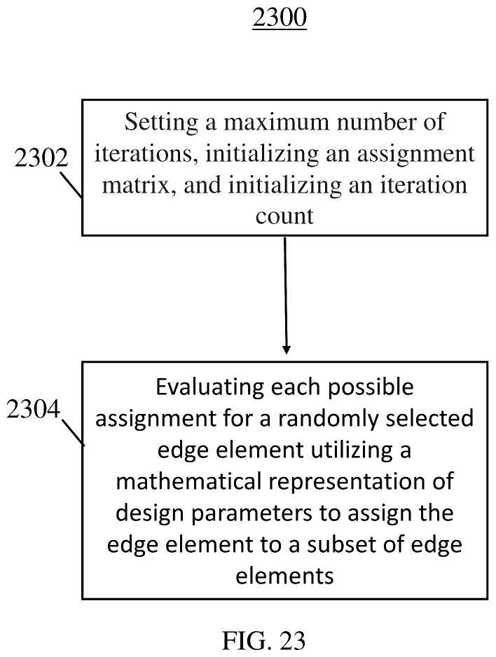

FIG. 22 is a flowchart of a method 2200 to orient the plurality of components for multi-point focusing. Similar to the example shown in FIG. 21, components in the form of edge elements are described for the sake of simplicity, but other types of components and corresponding diffraction patterns may be utilized to provide the desired RF field. Step 2202 includes partitioning each edge element into mutually exclusive subsets (an edge element is assigned to a single subset). Assuming the number of desired focal points N is greater than zero, then each edge element is assigned to one of the N+1 mutually exclusive subsets that include an idle subset and N focal point subsets. That is, a first plurality of edge elements will be assigned to a first subset (i.e., first focal point subset) that is responsible for generating/amplifying the RF field at a first desired focal point. Likewise, a second plurality of edge elements will be assigned to a second subset (non-overlapping with the first sub-set) that is responsible for generating/amplifying the RF field at a second desired focal point. The edge elements in a focal point subset form a control knob to focus a Keller cone onto a predetermined point. In one aspect, an equal number of edge elements are allocated to the focal point subsets for fair resource distribution. In another aspect, the edge elements of a focal point subset are spatially grouped (spatially connected), Partitioning the edge elements into mutually exclusive subsets may be described as an optimization problem that may be represented by the following equation:

$${min}_{{a}_{ij} ∈ {𝒯}_{ij}} ( \frac{1}{2} {\sum }_{i , j} {v}_{ij} + {max}_{k , l ∈ \{ 1 , … , K \}} ( \vert {μ}_{k} \vert - \vert {μ}_{l} \vert ) ) \qquad ( 12 )$$

where [symbol] ⊆{1, . . . , K} is the set of targets to which the edge element at (i, j) can positively contribute according to equation 11; aᵢⱼ∈ [symbol] indicates the target to which edge element (i, j) is eventually assigned where (i, j)∈{(i,j)∥ [symbol] |>0}; vᵢⱼ is the number of neighbors of (i, j) that belong to a partition different from aᵢⱼ. The first term of equation 12, ½Σ_{i,j} vᵢⱼ, encourages partitions that are spatially connected, and the second term balances the number of assigned edge elements per focal point by giving the largest pairwise difference in partition sizes. Thus equation 12 may be utilized to optimize the subset assignments of each edge element such that the elements of a subset are spatially contiguous, and resource distribution is substantially equal. However, equation 12 may be modified to modify the spatial connectivity or the resource distribution. For example, weighting factors may be added to the first term and/or the second term of equation 12 to give more importance to either spatial connectivity or equal resource allocation. In some embodiments, the second term of equation 12 is modified to tune the extent that the RF diffraction element resources (components) are allocated to a particular focal point. In at least one embodiment, equation 12, or a modified equation 12, is iteratively solved to determine a subset assignment for each edge element while the subset assignments for the other edge elements are fixed. An exemplary method that may be utilized for step 2202 is discussed below with reference to FIG. 23.

Step 2204 includes executing method 2100 for each focal point subset to orient the edge elements of each focal point subset towards their respective point and to orient the edge elements of the idle subset into an idle orientation.

A benefit of method 2200 is that prohibitive computational complexity is not required to converge to an acceptable solution because partitioning the edge elements and orienting the partitioned edge elements are mutually exclusive steps.

FIG. 23 illustrates a flowchart for a method 2300 that may be utilized for step 2202 of method 2200. In some embodiments, method 2300 iteratively approximates solutions for equation 12 that converge to an optimal solution for the assignment of the components to a mutually exclusive subset. Method 2300 may be described as a random walk with a Metropolis filter. One aspect of method 2300 is that the computational complexity is O(1) for a single iteration. Thus, method 2300 may be utilized to quickly determine partitions that meet design goals. As one example, method 2300 was executed on a 4^{th} generation Intel® CPU and a partition meeting the design goals was generated in 71 seconds.

Step 2302 includes setting a maximum number of iterations, initializing an assignment matrix, and initializing an iteration count. In some implementations, the assignment matrix is initialized by sampling uniformly from the set of targets ( [symbol] ) for every i,j. Equation 11 discussed above may be utilized to evaluate positive contribution by a component.

Step 2304 includes evaluating each possible assignment for a randomly selected component utilizing a mathematical representation of design parameters to assign the component to a subset of components. For evaluation of the randomly selected component, the subset assignments for the other components are fixed. In some implementations, equation 12 is the mathematical representation. In other implementations, a weighted equation 12 is the mathematical representation. Step 2304 may further include plotting the gain for an assignment for comparison purposes. For example, a Boltzmann distribution with temperature T=10 log(c) for a target point (aᵢⱼ) may be utilize for comparison. For example, a higher temperature may represent a larger gain.

For example, in one embodiment, given a plurality of desired focal points, each component (e.g., edge element) is selected and analyzed to determine if a configuration of the component exists that results in a positive contribution to the field at a randomly selected focal point. If no configuration exists that satisfies the criteria then the component is added to the group of idle components. If the criteria is satisfied the element is added to a subset of components that also provide a positive contribution to the randomly selected focal point.

This process is repeated for a given number of iterations. For each selected element, a score is generated of the overall partition quality if the element were assigned to a particular target. Using one or more criteria to score the partition, such as spatial contiguity or maximum difference in the number of elements assigned to the plurality of targets, the element may be assigned to a new target and the process repeats. In other embodiments, various other methods may be utilized to assign the elements to the various sub-groups to generate the desired multi-focus RF field.

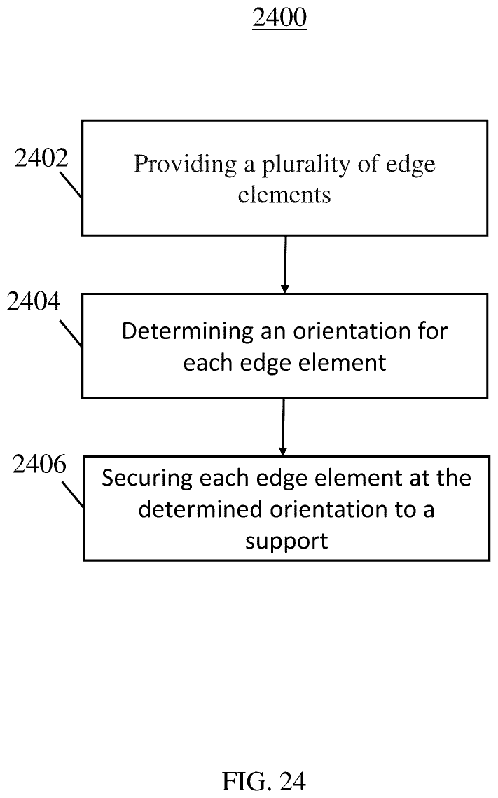

FIG. 24 illustrates a method 2400 for manufacturing an RF diffraction element according to some embodiments. Step 2402 includes providing a plurality of diffraction-inducing components. As discussed above, components that may be utilized include thin plates, wedges, dents, corrugated surfaces, material discontinuities, or combinations thereof, among others. We next continue the discussion assuming the components are edge elements. Step 2402 may include manufacturing the plurality of edge elements. Cutting edge elements from a sheet of material is one exemplary method of manufacturing the edge elements. In some embodiments, the edge elements have a large aspect ratio (length:width). In one implementation, the aspect ratio is 2:1. In another implementation, the aspect ratio depends on a wavelength for the waves emitted by the transmitter. For example, the aspect ratio may be λ/2:λ/4. In at least one embodiment, the material utilized to manufacture the edge element reflects a signal wave. For example, the material may be a metallic material. A non-limiting example of a metallic material is steel.

Step 2404 includes determining an orientation for each edge element. Step 2404 may further include determining a location for each edge element on a support. In some embodiments, step 2404 includes executing method 1900. For example, method 1900 may be utilized to manufacture an RF diffraction element for single point focusing. In other embodiments, step 2404 includes executing method 2200. For example, method 2200 may be utilized to manufacture an RF diffraction element for multi-point focusing. In at least one embodiment, the positions of the transmitter and the RF diffraction element may be standardized to simplify the set up of the system in the field. For example, in some implementations, for determining the orientation of each edge element, the position of the transmitter is set as the origin of the coordinate system, the position of the RF diffraction element is set at in the X-Z plane at y=yₛ, and half of the edge elements are assigned a position above the X-Z plane and half of the edge elements are assigned a position below the X-Z plane so that the transmitter is placed in the middle of the RF diffraction element when the system is set up in the field.

Step 2406 includes securing each edge element at the determined orientation to a support. In some embodiments, step 2406 includes cutting a slot for each edge element into a support where the slot is configured to secure a respective edge element at the predetermined location and at the determined orientation. These embodiments may be utilized to manufacture a static RF diffraction element. In other embodiments, step 2406 includes securing an actuator for each edge element to the support at the predetermined location where the actuator is configured to modify the orientation of the edge element from the predetermined orientation to one or more other orientations. These embodiments may be utilized to manufacture an active RF diffraction element.

In some implementations the support utilized in step 2406 is planar (2D). In other implementations the support is 3D. For a 3D support, step 2402 and step 2404 may be executed for each side. In at least one embodiment, the support does not reflect an incident signal wave. For example, a plastic material may be utilized to manufacture the support. In some implementations, the support is manufactured from a non-reconfigurable material. A non-reconfigurable material may be utilized for static RF diffraction elements. Acrylonitrile butadiene styrene (ABS) is one non-limiting example of a non-reconfigurable material that may be utilized to manufacture a static RF diffraction element. In other implementations, the support and/or the edge elements are manufactured from a reconfigurable material (smart material). A reconfigurable material may be utilized for reconfigurable RF diffraction elements. Liquid crystal elastomers (LCEs) are one non-limiting example of a reconfigurable material that may be utilized to manufacture a reconfigurable RF diffraction elements.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of sensing attributes of an area, a scene or an entity of interest, the method comprising:
receiving at one or more receiving units a signal transmitted from one or more transmitting units,
measuring one or more attributes of the received signal; and
using, at least in part, wave diffraction principles for sensing.

2. The method of claim 1, wherein the signal is a radio frequency (RF) signal.

3. The method of claim 1, wherein the signal is a WiFi signal, a mmWave signal, a cellular signal, or a Bluetooth signal.

4. The method of claim 1, wherein the one or more attributes of the received signal includes at least one of received signal strength, received signal strength indicator (RSSI), Channel State Information (CSI) measurement, signal-to-noise ratio (SNR), received channel power indicator (RCPI), received signal, phase measurement, or phase measurement difference.

5. The method of claim 1, further including:
generating an image of the area, scene, or entity of interest.

6. The method of claim 1, further including:
generating an edge map, generating an edge image, or tracing the edges of the area, scene, or entity of interest.

7. The method of claim 1, wherein wave interaction in the form of diffraction off of the surfaces with small enough curvatures are used.

8. The method of claim 1, wherein wave interaction in the form of diffraction off of the edges of the objects or entities in the area of interest are used.

9. The method of claim 1, wherein Keller cones off of the surfaces with small enough curvatures are used.

10. The method of claim 1, further comprising:
generating a theoretical, or algorithmic model that is at least in part based on the wave interaction with the surfaces with small enough curvatures.

11. The method of claim 1, wherein generating the image comprises identifying an edge orientation per each voxel of the scene of interest.

12. The method of claim 11, wherein identifying an edge orientation for each voxel in the sensing space of interest further comprises using Keller-cone-based models.

13. The method of claim 12, further comprising:
generating a theoretical or algorithmic model that is at least in part based on finding plausible edges and their corresponding orientations in the sensing area of interest using wave diffraction principles.

14. The method of claim 1, further including modeling the space of interest as a graph.

15. The method of claim 1, further including machine-learning-based methods.

16. The method of claim 1, wherein at least one signal detector is a receiver antenna.

17. The method of claim 1, wherein at least one signal detector is a plurality of receiver antennas arranged in a grid.

18. A device for RF field programming, multi-beam focusing, or beam-forming comprising a plurality of diffraction-inducing components.

19. The device of claim 18, wherein the plurality of diffraction-inducing components comprises thin plates, wedges, dents, corrugated surfaces, material discontinuities, or combinations thereof.

20. A method for RF field programming, multi-beam focusing or beam-forming, the method comprising:
transmitting signals from one or more transmitters;
utilizing at least in part a plurality of diffraction-inducing components;
determining, adjusting, or reconfiguring the characteristics of at least some of the diffraction-inducing components, wherein said characteristics affect the diffraction properties of the components; and
generating the desired RF field by using, at least in part, diffraction principles to model the relationship between the characteristics of the diffraction-inducing components and the resulting field.
